(19) United States
(12) Patent Application Publication
(10) Pub. No.: US 2024/0168821 A1
(43) Pub. Date: May 23, 2024

(54) SERVER, SYSTEM AND CONFIGURATION METHOD FOR GENERATING CONFIGURATION INFORMATION FOR A MULTI-SYSTEM PLATFORM

(71) Applicant: SAFRAN AEROSYSTEMS, Plaisir (FR)

(72) Inventor: Roberto MAZO, MOISSY-CRAMAYEL (FR)

(21) Appl. No.: 18/284,797

(22) PCT Filed: Mar. 29, 2022
(86) PCT No.: PCT/FR2022/050585

§ 371 Date: Sep. 28, 2023

(30) Foreign Application Priority Data
Apr. 2, 2021 (FR) FR2103462

(51) Int. Cl. G06F 9/50; G06F 8/71

(52) U.S. Cl. CPC G06F 9/5055; G06F 8/71; G06F 9/5044

(57) ABSTRACT

A configuration server generates configuration information of a multi-system platform including hardware and software resources shared by different functional systems of an aircraft or spacecraft. The configuration server includes a connection module, adapted to establish a remote connection with a plurality of configuration clients, a storage unit (110) adapted to store configuration information relating to the hardware and/or software resources allocated to each functional system, and a system configuration module (112) accessible by means of different system configuration profiles associated respectively with the different functional systems, adapted to generate configuration information for a functional system associated with the system configuration profile used for connection between the connection module and a configuration client, according to the hardware and/or software resources allocated to said functional system.

### TECHNICAL FIELD

The present invention relates to the field of embedded systems, and more particularly relates to the configuration of multi-system platforms (also known as multi-user platforms).

The present invention finds an advantageous, yet in no way limiting, application for the configuration of multi-system platforms intended to be embedded in aircrafts.

### PRIOR ART

Conventionally, an aircraft, for example an airplane, should carry several functional systems to carry out different functions inside the airplane. The functional systems of an airplane, as well as the specifications they should comply with, are defined in particular by the “Air Transportation Association for America” or ATA. For example, the ATA-21 specification covers the functional systems relating to air conditioning and pressurisation functions, the ATA-28 specification covers the functional systems relating to fuel storage, distribution and metering functions, the ATA-33 specification covers the functional systems relating to lighting functions, etc.

The functional systems of an airplane have traditionally been implemented according to a so-called federated architecture, in which each functional system was equipped with one or more standalone and dedicated computer(s) (“Line Replaceable Unit” or LRU).

With the increase in the computing capacities of computers and the number of functional systems on-board airplanes, but also because of a need to reduce the manufacturing costs of said airplanes, a new so-called multi-system architecture has been proposed, complying with the segregation constraints related to security of the functional systems. In such a multi-system architecture, the same computer (or more generally the same hardware and/or software resource) may be used by different functional systems of the airplane. Hence, such a computer is a multi-user computer, the different users corresponding to different functional systems of the airplane.

For example, a platform carrying out the electrical generation, distribution and conversion functions, in accordance with the ATA-24 specification, is intended to be used by different functional systems requiring the use of electrical signals (power supply, sensor measurements, actuator commands, etc.), and may be implemented according to a multi-system architecture to carry out all or part of the functions of other functional systems.

Nonetheless, the configuration tools of current multi-system platform require manual activity to coordinate the generation of the configuration information of the different functional systems. These are generated independently for each functional system and integrated manually in a second step.

### DISCLOSURE OF THE INVENTION

An objective of the present invention is to overcome all or part of the limitations of the solutions of the prior art, in particular those set out hereinbefore, by providing a solution allowing in particular facilitating the configuration of a multi-system platform.

To this end, and according to a first aspect, a configuration server is provided for generating configuration information of such multi-system platform, said multi-system platform including hardware and software resources shared by different functional systems of an aircraft or spacecraft in which said multi-system platform is intended to be embedded. Said configuration server includes:
a connection module, adapted to establish a remote connection with a plurality of configuration clients,
a storage unit adapted to store configuration information relating to the hardware and/or software resources allocated to each functional system,
a system configuration module accessible by means of different system configuration profiles associated respectively with the different functional systems, adapted to generate configuration information for a functional system associated with the system configuration profile used for connection between the connection module and a configuration client, according to the hardware and/or software resources allocated to said functional system.

Thus, the generation of configuration information of the different functional systems using the resources of a multi-system platform is carried out on the same centralised configuration server, to which the different functional system suppliers could connect remotely in order to generate their own configuration information. The configuration tool is multi-user for the integration of configurations of several functional systems, with a sharing process integrated into the tool.

Such arrangements firstly allow coordinating the generation of the configuration information. Indeed, the configuration information representative of the resources allocated to the different functional systems are stored in the same central storage unit accessible by the configuration server. Hence, this allows reducing the risks of having resources allocated simultaneously to two different functional systems, or of having functional system suppliers that would use different versions of the configuration information of the shared resources, etc. Furthermore, the different configuration information, stored in a centralised manner, no longer need to be exchanged between the different suppliers and the integrator of the multi-system platform. This also allows facilitating the integration and the certification of said multi-system platform.

Because the generation of configuration information is done in a centralised manner, by means of the same tool on the same piece of equipment (configuration server), the risks of incompatibilities between configuration information with respect to configuration information generated with tools installed on different equipment, which may in particular use different operating systems Windows®, Linux, Unix, etc., are reduced. This also allows facilitating the integration and the certification.

Furthermore, this also reduces complexity for the functional system suppliers, in particular, each no longer having to support and maintain a piece of equipment dedicated to the execution of a configuration tool. One single piece of equipment is required (configuration server), which facilitates maintenance by one single actor, for example the supplier or integrator of the multi-system platform. The proper operation of each piece of equipment on which a configuration tool is installed should also be guaranteed for certification, and one could understand that this is simpler when one single piece of equipment is used by all actors involved in the development of the multi-system platform.

In particular embodiments, the configuration server may also include one or more of the following characteristics, considered separately or in any technically feasible combinations.

In particular embodiments, the configuration server includes a platform configuration module for generating a multi-system platform model describing hardware and software resources that can be used by the functional systems, said platform configuration module being accessible by means of a platform configuration profile.

In particular embodiments, the system configuration module is adapted to generate a request for hardware and/or software resource allocation for a functional system associated with a system configuration profile used for connection between the connection module and a configuration client. Said configuration server further includes a supervision configuration module for allocating hardware and/or software resources according to the allocation requests, said supervision configuration module being accessible by means of a supervision configuration profile.

In particular embodiments, the supervision configuration profile allows access to all the configuration information of the multi-system platform. For example, the supervision configuration profile is used by an integrator of the multi-system platform.

In particular embodiments, each system configuration profile allows access to the configuration information of the functional system associated with said system configuration profile, but does not allow access to the configuration information associated with other functional systems. Such arrangements allow ensuring that the configuration information of one functional system are not corrupted during the generation, by the configuration server, of configuration information of another functional system.

In particular embodiments, the configuration server includes a centralised version management module.

In particular embodiments, the configuration server includes an administration module for managing the configuration profiles.

According to a second aspect, a configuration system is provided for generating configuration information for a multi-system platform, including a configuration server according to any one of the embodiments of the invention, and a plurality of configuration clients adapted to connect remotely to the configuration server using different configuration profiles.

According to a third aspect, a configuration method is provided, implemented by a configuration server, for generating configuration information of a multi-system platform, said multi-system platform including hardware and software resources shared by different functional systems of an aircraft or spacecraft in which said multi-system platform is intended to be embedded. Said configuration method includes:
establishing a remote connection with a configuration client by means of a system configuration profile among different system configuration profiles associated respectively with the different functional systems,
obtaining, from a storage unit storing configuration information relating to hardware and/or software resources of the multi-system platform allocated to each functional system, hardware and/or software resources allocated to the functional system associated with the system configuration profile used for connection with the configuration client,
generating configuration information for the functional system associated with the system configuration profile used for connection with the configuration client, according to the hardware and/or software resources allocated to said functional system.

In particular implementations, the configuration method may further include one or more of the following features, considered separately or in any technically feasible combinations.

In particular implementations, the configuration method includes:
establishing a remote connection with a configuration client by means of a platform configuration profile,
generating a multi-system platform model describing hardware and software resources that can be used by the functional systems.

In particular implementations, the configuration method includes:
generating a request for hardware and/or software resource allocation for a functional system associated with a system configuration profile used for connection with a configuration client,
establishing a connection with a configuration client by means of a supervision configuration profile,
allocating hardware and/or software resources based on allocation requests, by means of the configuration client connected with the supervision configuration profile.

In particular implementations, the configuration method includes:
establishing a connection with a configuration client by means of an administration profile,
managing configuration profiles authorised to generate and/or use configuration information of the multi-system platform, by means of the configuration client connected with the administration profile.

According to a fourth aspect, a computer program product is provided including a set of program code instructions which, when they are executed by a processor, configure said processor to implement a configuration method according to any one of the implementations of the invention.

According to a fifth aspect, a computer-readable storage medium is provided on which a set of program code instructions is stored which, when they are executed by a processor, configure said processor to implement a configuration method according to any one of the implementations of the invention.

### PRESENTATION OF THE FIGURES

The invention will be better understood upon reading the following description, given as a non-limiting example, and made with reference to the figures which represent:

FIG. 1: a schematic illustration of a configuration system of a multi-system platform,

FIG. 2: a schematic illustration of a configuration server of a multi-system platform,

FIG. 3: a diagram illustrating the main steps of a method for configuring a multi-system platform,

FIG. 4: a diagram illustrating the main steps of a preferred implementation of a method for configuring a multi-system platform.

In these figures, identical references from one figure to another refer to identical or similar elements. For clarity, the illustrated elements are not plotted to scale unless stated otherwise.

### DESCRIPTION OF THE EMBODIMENTS

As indicated hereinabove, the present disclosure relates to the generation of configuration information for a multi-system platform. In the following description, the case of the configuration of a multi-system platform intended to be embedded on an aircraft is considered without limitation.

In the following description, the case where the considered multi-system platform corresponds to a platform carrying out the electrical generation, distribution and conversion functions, in accordance with the specification ATA-24, is considered without limitation.

As indicated before, such an ATA-24 multi-system platform includes hardware (network of electrical distribution cables, input/output cards, communication cards, computers, etc.) and software (library of software functions, etc.) resources which could be used by other functional systems.

For example, the ATA-24 multi-system platform could be connected to sensors and/or actuators used by a functional system, which could therefore use the ATA-24 multi-system platform to recover the measurements performed by the sensors and to emit commands to the actuators, but also to process the corresponding signals by the computers of said ATA-24 multi-system platform. In the context of an ATA-24 multi-system platform, the functional systems include the ATA-24 system and other functional systems, distinct from the ATA-24 system.

In the context of such a multi-system platform, the configuration information are for example organised in the form of configuration parameter tables (in any suitable form, for example in the XML, Excel®, CSV format, etc.), and the generation of configuration information amounts to defining the values of these configuration parameters.

For example, the configuration information for a given functional system comprise information relating to the hardware and/or software resources allocated to this functional system.

In particular embodiments, the configuration information may also include, for example, the application code describing the functions carried out on the multi-system platform for the considered functional system, as well as the associated data (including the configuration parameter values), which will be loaded onto the multi-system platform.

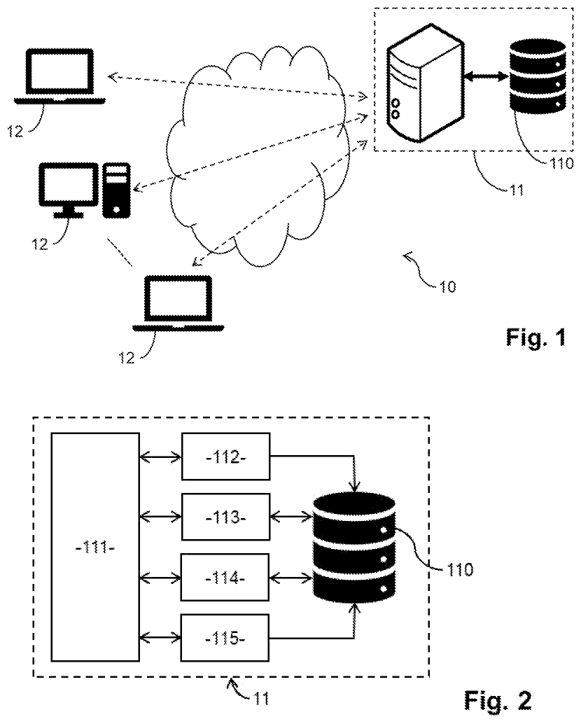

FIG. 1 schematically shows an example of a system 10 for configuring a multi-system platform, such as an ATA-24 multi-system platform in the example considered herein.

As illustrated in FIG. 1, the configuration system 10 includes in particular a configuration server 11, and configuration clients 12 adapted to remotely connect to the configuration server 11. Thus, the architecture of the configuration system 10 is centralised, according to a client/server architecture in which different configuration clients 12 can connect to the same centralised configuration server 11 to generate configuration information for the ATA-24 multi-system platform.

The configuration clients 12 may be used by different actors involved in the development, validation and certification of the ATA-24 multi-system platform. Each supplier of one of the functional systems of the ATA-24 multi-system platform is an actor that have to generate configuration information for said ATA-24 multi-system platform, and is likely to connect to the configuration server 11 via a client configuration 12. Furthermore, the supplier of the ATA-24 multi-system platform, which will be used by the different functional systems, is also an actor who has to supply or generate configuration information of the ATA-24 multi-system platform, and, to do so, might, in preferred embodiments, connect to the configuration server 11 via a configuration client 12. In addition, the integrator of the ATA-24 multi-systems platform, who is in charge of integrating the deliverables of the different actors involved in the ATA-24 multi-systems platform, could also, in preferred embodiments, connect to the configuration server 11 via a configuration client 12.

Preferably, different actors use different respective configuration profiles to connect to the configuration server 11 via a configuration client 12.

For example, a supplier of a functional system could use a system configuration profile. Different system configuration profiles are associated respectively with the different functional systems and their suppliers, in order to enable each functional system supplier to modify only the configuration information associated with its functional system, without modifying the configuration information of the other functional systems for which it is not responsible.

In particular embodiments, the supplier of the ATA-24 multi-system platform could use a platform configuration profile to connect to the configuration server 11, the integrator of the ATA-24 multi-system platform could use a supervision configuration profile to connect to the configuration server 11, etc.

For example, the configuration clients 12 are identical, regardless of the configuration profile used to connect to the configuration server 11. For example, this may be the case if the configuration tool is implemented as a web application on the configuration server 11, in which case each configuration client 12 corresponds to a web browser installed on a computer, or else if the configuration clients 12 correspond to the same application on different computers belonging to the different actors, etc.

According to other examples, the configuration 12 clients are not all the same. For example, the configuration client 12 may depend on the used configuration profile type (system, platform, supervision, etc.). In such a case, the configuration clients 12 used with configuration profiles of different types correspond to different applications, which differ for example by the graphical interface, the functions implemented on the configuration client 12 side, etc.

In all cases, regardless of the considered configuration client 12 type (web browser, application to be installed on a computer, etc.) and the functionalities supplied by the configuration client 12, it should be noted that the generation of configuration information is always carried out on the configuration server 11. Thus, when the configuration information should be generated, the configuration client 12 uses a configuration information generation module, called “configuration module”, which is installed and executed on the configuration server 11.

FIG. 2 schematically shows a preferred embodiment of a configuration server 11.

As illustrated in FIG. 2, the configuration server 11 includes in particular a connection module 111 adapted to establish a remote connection with a plurality of configuration clients 12.

The configuration server 11 also includes a storage unit 110 adapted to store configuration information of the ATA-24 multi-system platform, and in particular those generated by the configuration server 11 connected to a configuration client 12. In particular, the storage unit 110 is adapted to memorise the configuration information relating to the hardware and/or software resources allocated to each functional system.

Preferably, the storage unit 110 also stores information relating to the different configuration profiles that are authorised to access the configuration server 11, as well as the associated rights and data. From a system configuration profile associated with a given functional system, the configuration server 11 could therefore recover in the storage unit 110 the configuration information relating to the allocated hardware and/or software resources, the configuration information generated with this system configuration profile for this functional system, etc. Preferably, the configuration server 11 includes a centralised version management module (not shown in the figures). Thus, the history and the successive versions of the configuration information stored in the storage unit 110 are stored, and the configuration server 11 therefore allows quickly identifying all the configuration information associated with a given version thereof.

In general, the storage unit 110 may include any type of non-volatile storage means. For example, the storage unit 110 includes one or more database(s) accessible by the configuration server 11.

As illustrated in FIG. 2, the configuration server 11 also includes a system configuration module 112 accessible by means of different system configuration profiles associated respectively with the different functional systems. The system configuration module 112 is configured to generate configuration information of the different functional systems. In particular, the supplier of a given functional system could connect to the system configuration module 112 using its system configuration profile, via a configuration client 12 and the connection module 111, and generate configuration information for the considered functional system according to the configuration information relating to the hardware and/or software resources allocated to said functional system which have been recovered from the storage unit 110. Preferably, the configuration information thus generated are also stored in the storage unit 110.

In preferred embodiments, and as illustrated in FIG. 2, the configuration server 11 may also include a platform configuration module 113. The platform configuration module 113 is used by the supplier of the ATA-24 multi-system platform to generate configuration information which correspond to a model describing the hardware and software resources of said ATA-24 multi-system platform, in particular those that can be used by the functional systems. For example, the supplier of the ATA-24 multi-system platform could connect to the platform configuration module 113 using its platform configuration profile, via a configuration client 12 and the connection module 111. For example, the model of the ATA-24 multi-system platform indicates the number and type of computers, the number and type of input/output cards as well as the ports to which they are physically connected, the number and type of communication cards and the ports to which they are physically connected, etc.

In particular embodiments, and as illustrated in FIG. 2, the configuration server 11 may also include a supervision configuration module 114, accessible by means of a supervision configuration profile. For example, the integrator of the ATA-24 multi-system platform could connect to the supervision configuration module 114 using the supervision configuration profile, to recover all the configuration information generated by the different actors (functional system suppliers, supplier of the ATA-24 multi-system platform, etc.). In the case where the configuration server 11 includes a centralised version management module, the integrator could directly recover all configuration information for a specific desired version, without any risk mixing configuration information of different functional systems that correspond to different versions of the configuration of the ATA-24 multi-system platform, possibly incompatible with each other.

In preferred embodiments, the supervision configuration module 114 is also configured to allocate hardware and/or software resources to the different functional systems, for example according to the model of the hardware and software resources supplied by the supplier of the ATA-24 multi-system platform (preferably via the platform configuration module 113). Preferably, the allocation of hardware and/or software resources is carried out according to allocation requests emitted by the different software system suppliers. For example, the system configuration module 112 may be configured to generate a hardware and/or software resource allocation request for a functional system associated with a system configuration profile used for connection between the connection module 111 and a configuration client 12. All of the allocation requests thus generated by the system configuration module 112 are accessible by the supervision configuration module 114, which enables the integrator to allocate the hardware and/or software resources to the different functional systems according to the received allocation requests. For example, the model of the ATA-24 multi-system platform, preferably stored in the storage unit 110, is used by the system configuration module 112 and by the supervision configuration module 114 to generate requests or allocate resources. The hardware and/or software resources allocated respectively to the different functional systems are stored in the storage unit 110, and each functional system supplier may have access to the resources which have been allocated thereto by connecting to the configuration server 11 using its system configuration profile.

It should be noted that the same functional system supplier may have several system configuration profiles. For example, a first system configuration profile may be used to emit hardware and/or software resource allocation requests, and a second system configuration profile may be used to generate configuration information using the configuration information relating to the allocated hardware and software resources, etc.

In preferred embodiments, and as illustrated in FIG. 2, the configuration server 11 may include an administration module 115 to manage the configuration profiles authorised to generate and/or use configuration information of the ATA-24 multi-system platform. For example, the administration module 115, for example accessible by means of an administration profile, allows adding, deleting and defining configuration profiles. For example, the administration profile may be the same as the supervision configuration profile.

For example, the configuration server 11 includes one or more processor(s) and storage means (magnetic hard disk, electronic memory, optical disk, or any type of computer-readable storage medium) in which a computer program product is stored, in the form of a set of program code instructions to be executed to carry out the functions of the different connection 111, 112, 113, 114 configuration 115 and administration modules. In one variant, the configuration server 11 includes one or more programmable logic circuit(s), of the FPGA, PLD, etc. type, and/or application-specific integrated circuits (ASIC) adapted to implement all or part of said functions of the different modules 111 of connection, 112, 113, 114 configuration and 115 administration.

In other words, the configuration server 11 includes a set of means configured using software (specific computer program product) and/or using hardware (FPGA, PLD, ASIC, etc.) to carry out the functions of the different modules 111 of connection, 112, 113, 114 configuration and 115 administration.

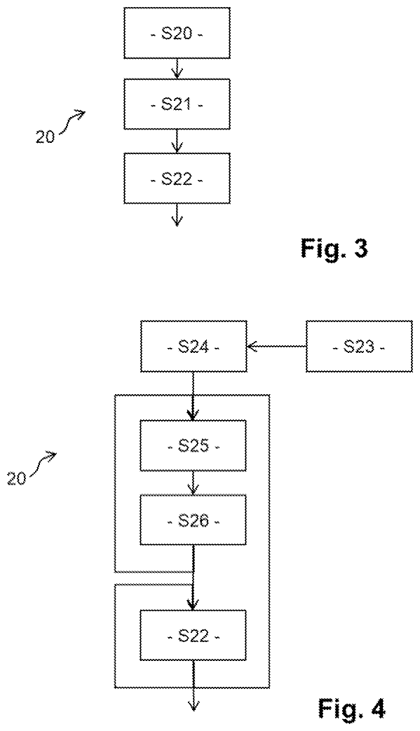

FIG. 3 shows the main steps of a method 20 for configuring the ATA-24 multi-system platform implemented by the configuration server 11. As illustrated in FIG. 3, the configuration method 20 includes:
a step S20 of establishing, by means of the connection module 111, a remote connection with a configuration client 12 by means of a system configuration profile amongst the different system configuration profiles associated respectively with the different functional systems,
a step S21 of obtaining, from the storage unit 110, configuration information relating to the hardware and/or software resources allocated to the functional system associated with the system configuration profile used for connection between the connection module 111 and the configuration client 12,
a step S22 of generating configuration information, by the system configuration module 112, for the functional system associated with the system configuration profile used for connection between the connection module 111 and the configuration client 12, according to the hardware and/or software resources allocated to said functional system; preferably, the generated configuration information are stored in the storage unit 110.

During the connection step S20, the configuration server 11 verifies that the configuration profile used for connection is actually an authorised configuration profile. In the example illustrated by FIG. 3, the used configuration profile is a system configuration profile and the configuration server 11 verifies that said system configuration profile is actually associated with one of the functional systems of the ATA-24 multi-system platform.

In preferred implementations, the connection step S20 may further implement any suitable authentication method, in order to verify that the person who connects with this system configuration profile is actually the functional system supplier to which this system configuration profile belongs.

After having verified the system configuration profile, the configuration server 11 recovers in the storage unit 110, during step S21, the configuration information relating to the hardware and/or software resources already allocated to the functional system associated with said system configuration profile used to connect to the configuration server 11.

Afterwards, during step S22, the functional system supplier uses the system configuration module 112 for generating configuration information for the ATA-24 multi-system platform, using the recovered configuration information relating to the hardware and/or software resources previously allocated to this functional system.

The steps illustrated in FIG. 3 are executed for each functional system. Preferably, these steps may also be executed several times for each functional system, to generate successive versions of the different configuration information which, where appropriate, may be indexed by a centralised version management module of the configuration server 11.

FIG. 4 schematically shows the main steps of a preferred implementation of the configuration method 20, in the case where the configuration server 11 includes all of the configuration modules shown in FIG. 2. For clarity, in FIG. 4, the steps of connection with the configuration clients 12 are not shown, but it should be noted that each step implementing a configuration module could be subject to the prior establishment of a connection with a configuration client 12 using a suitable configuration profile.

As illustrated in FIG. 4, the configuration method 20 firstly includes a step S23 of managing the configuration profiles by the administration module 115, using the administration profile. The management step S23 allows creating the different configuration profiles (platform, system, supervision, etc.) authorised to generate and use configuration information for the considered ATA-24 multi-system platform. For example, the information describing the created configuration profiles are stored in the storage unit 110 of the configuration server 11.

In this example, the configuration method 20 also includes a step S24 of generating configuration information corresponding to a model of the ATA-24 multi-system platform describing hardware and software resources that can be used by the functional systems. This generation step S24 is executed by the platform configuration module 113, using the platform configuration profile. The model of the ATA-24 multi-system platform thus generated is preferably stored in the storage unit 110 of the configuration server 11.

In this example, the configuration method 20 also includes a step S25 of generating a request for allocating hardware and/or software resources by the system configuration module 112, using a system configuration profile. For example, the system configuration module 112 allows visualising the model of the ATA-24 multi-system platform, in order to enable the supplier of the functional system to identify types of hardware and/or software resources necessary for the considered functional system, and generate an allocation request for these resources. The resource allocation request generation step S25 is typically executed for each functional system, each functional system supplier connecting to the configuration server 11 using its system configuration profile.

Where applicable, the configuration method 20 also includes a step S26 of allocating hardware and/or software resources according to the allocation requests, executed by the supervision configuration module 114 using the supervision configuration profile. For example, the supervision configuration module 114 allows visualising the received resource allocation requests, in order to enable the integrator to allocate hardware and/or software resources to the different functional systems. It should be noted that several resource allocation requests could be received for different functional systems. Since the supervision configuration profile allows access to all resource allocation requests, it is possible to arbitrate between two requests for the same hardware and/or software resource type, if the available hardware and/or software resources are not enough to address these two requests. Preferably, the supervision configuration module 114 is configured to prevent the allocation of the same resource to two distinct functional systems. Preferably, the configuration information relating to the hardware and/or software resources allocated upon completion of step S26 to each functional system are stored in the storage unit 110.

As illustrated in FIG. 4, the request generation S25 and allocation S26 steps may be iterated. For example, if a particular hardware or software resource could not be allocated to a functional system, it is possible to generate a new request for new hardware and/or software resources, etc.

In this example, the configuration method 20 also includes a step S22 of generating configuration information for a functional system, by the system configuration module 112 using the system configuration profile associated with the considered functional system. These configuration information for a given functional system describe in particular a use sequence of the hardware and software resources allocated to this functional system, for example in the form of an application code and associated data, or in the form of information enabling the supervision configuration module 114 to generate the application code and the associated data, etc. The configuration information generation step S22 is executed for each functional system, each functional system supplier connecting to the configuration server 11 using its system configuration profile. In particular, the configuration information generation step S22 uses the configuration information relating to the resources allocated to the considered functional system, obtained from the storage unit 110 (the obtaining step S21 not being shown in FIG. 4 for clarity).

As illustrated in FIG. 4, the configuration information generation step S22 may be iterated throughout developments for the same functional system. Furthermore, the developments may identify a new need for additional hardware and/or software resources. The request generation S25 and allocation S26 steps could then be iterated again to require complementary hardware and/or software resources, etc.

Once all the configuration information have been generated, these may be recovered by the integrator of the ATA-24 multi-system platform, which connects to the configuration server 11 using its supervision configuration profile. In a manner known per se, the development processes of are intrinsically iterative, and the integration/validation of the different configuration information of the ATA-24 multi-system platform will generally allow identifying problems requiring the execution of all or part of the steps of FIG. 4 again, etc.

More generally, it should be noted that the implementations and embodiments considered hereinabove have been described as non-limiting examples, and that other variants could consequently be considered.

In particular, the invention has been described while primarily considering the configuration of a multi-system platform intended to be embedded in an airplane, and more particularly an ATA-24 multi-system platform. Nonetheless, the invention is more generally applicable for the configuration of any type of multi-system platform intended to be embedded in an aircraft or spacecraft. Furthermore, the invention is applicable for fields other than the aerospace field, and is applicable in any field in which it could be considered to use multi-system platforms similar to those of the aeronautical field. For example, the invention is also applicable in the automotive or railway field.

1. A configuration server for generating configuration information of a multi-system platform, said multi-system platform including hardware and software resources shared by different functional systems of an aircraft or spacecraft in which said multi-system platform is intended to be embedded, characterised in that said configuration server includes:
a connection module, adapted to establish a remote connection with a plurality of configuration clients,
a storage unit adapted to store configuration information relating to the hardware and/or software resources allocated to each functional system, and
a system configuration module accessible by means of different system configuration profiles associated respectively with the different functional systems, adapted to generate configuration information for a functional system associated with the system configuration profile used for connection between the connection module and a configuration client, according to the hardware and/or software resources allocated to said functional system.

2. The configuration server according to claim 1, including a platform configuration module for generating a multi-system platform model describing hardware and software resources that can be used by the functional systems, said platform configuration module being accessible by means of a platform configuration profile.

3. The configuration server according to claim 1, wherein the system configuration module is adapted to generate a request for hardware and/or software resource allocation for a functional system associated with a system configuration profile used for connection between the connection module and a configuration client, said configuration server including a supervision configuration module for allocating hardware and/or software resources according to the allocation requests, said supervision configuration module being accessible by means of a supervision configuration profile.

4. The configuration server according to claim 3, wherein the supervision configuration profile allows access to all the configuration information of the multi-system platform.

5. The configuration server according to claim 1, wherein each system configuration profile allows access to the configuration information of the functional system associated with said system configuration profile, but does not allow access to the configuration information associated with other functional systems.

6. The configuration server according to claim 1, including a centralised version management module.

7. The configuration server according to claim 1, including an administration module for managing the configuration profiles.

8. A configuration system for generating configuration information for a multi-system platform, including a configuration server according to claim 1, and a plurality of configuration clients adapted to connect remotely to the configuration server using different configuration profiles.

9. A configuration method, implemented by a configuration server, for generating configuration information of a multi-system platform, said multi-system platform including hardware and software resources shared by different functional systems of an aircraft or spacecraft in which said multi-system platform is intended to be embedded, characterised in that said configuration method includes:
establishing a remote connection with a configuration client by means of a system configuration profile among different system configuration profiles associated respectively with the different functional systems,
obtaining, from a storage unit storing configuration information relating to hardware and/or software resources of the multi-system platform allocated to each functional system, hardware and/or software resources allocated to the functional system associated with the system configuration profile used for connection with the configuration client, and
generating configuration information for the functional system associated with the system configuration profile used for connection with the configuration client, according to the hardware and/or software resources allocated to said functional system.

10. The configuration method according to claim 9, including:
establishing a remote connection with a configuration client by means of a platform configuration profile,
generating a multi-system platform model describing hardware and software resources that can be used by the functional systems.

11. The configuration method according to claim 9, including:
generating a request for hardware and/or software resource allocation for a functional system associated with a system configuration profile used for connection with a configuration client,
establishing a connection with a configuration client by means of a supervision configuration profile,
allocating hardware and/or software resources based on allocation requests, by means of the configuration client connected with the supervision configuration profile.

12. The configuration method according to claim 9, including:
establishing a connection with a configuration client by means of an administration profile,
managing configuration profiles authorised to generate and/or use configuration information of the multi-system platform, by means of the configuration client connected with the administration profile.

13. (canceled)

14. A non-transitory computer-readable storage medium on which a set of program code instructions is stored which, when they are executed by a processor, configure said processor to implement a configuration method according to claim 9.
